(19) United States
(12) Patent Application Publication
(10) Pub. No.: US 2012/0084218 A1
(43) Pub. Date: Apr. 5, 2012

(54) System and a Method for Managing and Tracking the Overnight Accommodation of Traveling Personnel Away from Home Base

(76) Inventor: Ralph Michael Hall, Houston, TX (US)

(21) Appl. No.: 13/247,093

(22) Filed: Sep. 28, 2011

Related U.S. Application Data
(60) Provisional application No. 61/387,633, filed on Sep. 29, 2010.

(51) Int. Cl. G06Q 10/10

(52) U.S. Cl. 705/317

(57) ABSTRACT

A computer system and a method for tracking the rest periods of airline crew members in a hotel is disclosed. A hotel has access to a layover management module and crew check in module via the web. The hotel inputs information to the layover management module and the crew checks in through the crew check in module. Check in data is transmitted and stored in a central server which is accessible by the airline to track the rest periods of its crews.

### RELATED PRIORITY DATE APPLICATION

This application claims the benefit under 35 U.S.C. 119(e) of the U.S. provisional application No. 61/387633 filed on Sep. 29, 2010.

### TECHNICAL FIELD OF THE INVENTION

The present invention relates to the field of methods of doing business and, more particularly, to a method and a computer system for tracking the rest periods of airline flight crews when they are away from home base. Still more particularly, the present invention discloses a method and a computer system wherein the member of an airline flight crew on a multiple day pairing checks in a lodging establishment for the overnight stay via the internet when the member arrives at the lodging establishment to track the rest period of such member.

### BACKGROUND OF THE INVENTION

It is well known that airline flight crews on multiple day pairings spend a substantial amount of time away from home and are required to work long hours under substantially stressful conditions to fly the airplanes and serve their passengers. In order to protect the well being of the crews and the safety of the traveling public, laws have been enacted to ensure that the crews are sufficiently rested when they work during multiple day pairings and the airlines are required to keep track of those periods to ensure compliance. In the past, the crews' rest period started thirty minutes after block in and it was to monitor because of the recording and storing of the block-in information. Under new federal regulations, the airline crew rest period starts at the time the crew arrives at the lodging establishment such as a hotel, motel or the like. Those establishments do not record the check in time of its customers. Further, even if they recorded the check-in time, there is no interface with the airline to provide the check-in information so that the airline can properly monitor its crews' rest periods.

The manual recording of the crew check in times by the lodging establishment, the transfer thereof to the airline and the processing thereof by the airline is very time consuming, labor intensive, inefficient and prone to error. According to the present invention, a method and a computer system is disclosed that allows for the accurate and efficient recording and processing of the crew rest periods to ensure full compliance.

These and other advantages of the present invention will become apparent from the following description and drawings. The present invention was developed to change this process.

### SUMMARY OF THE INVENTION

A computer system and a method for tracking the rest periods of airline crews in overnight layovers is disclosed. A crew accommodations sign in system is available in a website accessible through the INTERNET and provides a layover management module for the hotel and a web based crew member check in at the hotel. Each hotel has log in access to the website to access the layover management module for the hotel which provides the daily schedule. The hotel enters room assignments, folio numbers and lobby times for the crew's departure.

The check in module is accessed via the web by the crews when they arrive at the hotel. Each crew member enter his inbound flight number, outbound flight number and crew position together with his employee number and name. The room assignment and lobby time has already been inputted by the hotel and appears by each crew member's data.

All entered data including the data for the hotel and the crew with a date and time stamp indicating when the check in occurred is transmitted and stored in a central server which can be accessed by the subject airline. The airline may use that data to track the crew rest periods and to ensure that the laws governing the same are complied with. Further, the airline may use the data for other purposes such as accessing the room number of the crew member.

### BRIEF DESCRIPTION OF THE DRAWINGS

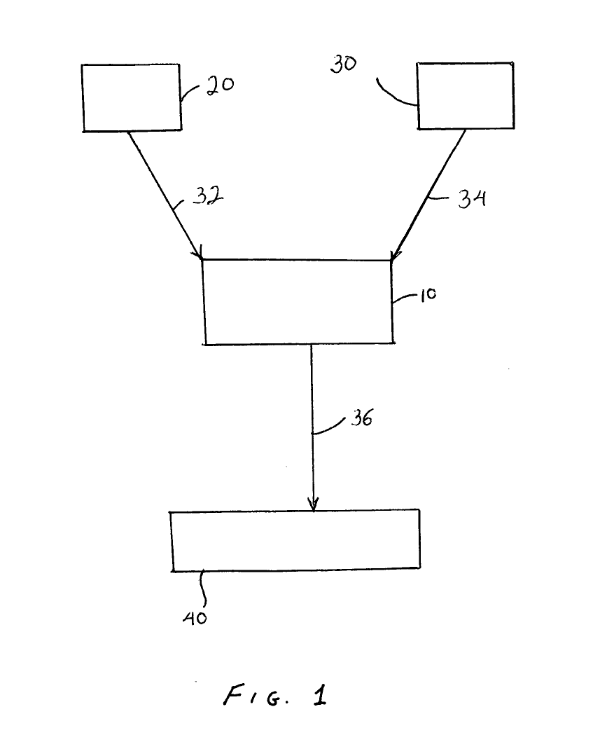

For a detailed description of the invention, reference will be made to the accompanying drawings wherein FIG. 1 is a block diagram depicting the method and system of the present invention.

### DETAILED DESCRIPTION OF THE PREFERRED EMBODIMENTS

The present invention discloses a computer system and a method for tracking the rest periods of airline carrier crews when they are away from home base and check in establishments providing lodging such as hotels, motels or other similar establishments during overnight layovers. The carrier may be a commercial airline company, an air freight company, a letter or package courier or any other business that utilizes crews that have overnight layovers away from home base and which need to track the rest period of the crews because of regulatory or other considerations. Similarly, the computer system and the method may be used by any organization or business entity having personnel that travel on a regular basis with overnight layovers away from home base or any organization or business entity that manages or schedules the overnight accommodations of people in establishments providing lodging and need to track the rest period of their personnel or their check in times in lodging establishments.

The present invention will now be described in connection with a typical utilization by a commercial airline company to manage, monitor, track and make available for auditing the rest periods of its crews in hotels while away from their home base. It should be understood, however, that other users referred to above may utilize the system and the method similarly in connection with any establishment providing lodging.

Several terms are used herein which are well known in the airline industry. Some of those terms are further defined herein to further clarify the invention, as follows:

“Crew member or flight crew member” is a member of a flight crew i.e., a pilot, a flight engineer, a mechanic, a navigator, a steward or a flight attendant who is assigned to a specific flight.

“Crew rest” is the period of time in a pairing (defined hereinafter) between days that the crew member is not assigned flying.

“Day” is the series of legs that are flown by a crew member in a continuous flow, unbroken by a period of crew rest.

“Pairing or trip” is a series of legs spanning a single or multiple days.

“Layover or overnight” is the period of crew rest between days on a multiple day pairing and which is usually spent in a hotel that the airline has a contract with for the accommodation of crew members.

“Crew base” is the assigned work location of a crew member.

In a commercial airline operation, a crew accommodations sign in system in accordance with the present invention is available in a website accessible through the INTERNET and provides a layover management system for the hotel, and a web based crew member check in at the hotel when the crew member arrives at the hotel.

The layover management system provided for the hotel includes a layover management module for the hotel. Each hotel has log in access to the website of the crew accommodations sign in system to access the layover management module for the hotel. In the management module so accessed, the hotel is presented with a daily schedule. The hotel prepares for a new day by entering room assignments, folio numbers and lobby times for the crew's departure. The hotel is able to print daily manifests from this module which includes checked in crew member information. The hotel is also able to print monthly data that can be used for invoicing. The use of this resource increases the accuracy of the data that is entered into the hotel reservation systems.

In addition to the layover management module for the hotel, the crew accommodations sign in system provides a check in module for the crews to be accessed by the crews when they arrive at the hotel. The check in module is accessed through a computer provided by the hotel for use by the crews in accordance with the present invention. A printer is also provided by the hotel to print reports from the computer. When a crew arrives at the hotel, the hotel logs into the website of crew accommodations sign in system and, using its credentials, brings up the check in module for the crew. Each crew member then enters his inbound flight number, outbound flight number and crew position. The crew member is presented with a form to complete by entering his employee number and name. Room assignment and lobby time has already been inputted by the hotel and appears by each crew member's data. When the completed page is submitted there is an option to print and, upon exercising that option, a form is printed for each crew member which includes ID's, names, rooms and lobby times. Other data such as amenities can also be shown on the print out. If not logged out by a crew member, the system logs itself out after a defined time period.

All entered data including the data for the hotel and the crew is transmitted and stored in a central server. The data includes a date and time stamp indicating when the check in occurred. The data including the crew member's ID, name, room, check in date time and departure lobby date time is saved in that server for complete access by the commercial airline through a web services interface provided to the airline for that purpose. The airline may use that data to track the crew rest periods and to ensure that the laws governing the same are complied with. Further, the airline crew schedulers have access to the information as to the room number of a room being occupied by a crew member and there is no need to interface with the front desk.

Referring now to FIG. 1, there is shown a block diagram depicting the system and method of the present invention. There is shown central server 10 of crew accommodations sign in system accessible through the INTERNET by the hotel that provides a hotel management module 30 to the hotel and a crew check in module 30.

Hotel management module 20 has the daily schedule and the hotel prepares for a new day by entering room assignments, folio numbers and lobby times for the crew's departure. The hotel is able to print from hotel management module 30 daily manifests that include checked in crew member information and monthly data that can be used for invoicing.

Crew check in module 30 is accessible by the crews when they arrive at the hotel through a computer provided by the hotel. When a crew arrives at the hotel, the hotel accesses and brings up crew check in module 30 and each crew member checks in as described above by entering his employee number and name, inbound flight number, outbound flight number and crew position. Room assignment and lobby time has already been inputted by the hotel and appears by each crew member's data. The information may be printed out by each crew member.

The entered data from hotel management module 20 and crew check in module 30 is transmitted via transmissions 32 and 34, respectively, to central server 10 and is stored therein. The transmitted data includes a date and time stamp indicating when the check in occurred. The data stored in central server 10 is accessible by a commercial airline 40 via transmission 36 through a web services interface provided to the airline for that purpose.

There are several benefits derived from the present invention. As regards the hotel, the hotel is able to generate accurate information for invoicing, it does not need to store sign in sheets, and is able to access all layover information through the hotel management module. As regards the airline, the airline has access to crew member hotel check in time and departure lobby time allowing the computation of crew rest in compliance with the federal laws, has access to a crew members room number, and has the ability to track actual historical scheduled room usage. Further, the system may be utilized in ad hoc room assignment in contract hotels, open rooms can be tracked and the system can be set up easily in non contract hotels, with notice, on a short term basis. As regards the crews, the system provides a simple check in with privacy.

While a preferred embodiment of the invention has been described, modifications thereof can be made by one skilled in the art without departing from the spirit of the invention.

What is claimed is:

1. A method for tracking the rest period of an airline crew member in an overnight layover at an establishment that provides lodging, comprising:
generating an internet based layover management module for the establishment;
accessing the layover management module at the establishment;
checking in the crew member at the establishment;
recording a check in time for the crew member at the establishment in the layover management module; and
establishing a departure time from the establishment for the crew member in the layover management module.

2. A method as in claim 1 further including the step of transferring the check in time and the departure time to a server.

3. A method as in claim 1 further including the step of storing the check in time and the departure time.

4. A method as in claim 1 further including the step of storing the check in time and the departure time in the server.

5. A method as in claim 1 further including the step of entering a room assignment and a folio number for the crew member.

6. A method as in claim 1 further including the step of entering a scheduled departure time for the crew member.

7. A computer system for tracking the rest periods of an airline crew member in an overnight layover in an establishment that provides lodging, comprising:
a web based layover management module for the establishment;
means for accessing the layover management module at the establishment by the crew member via the internet for checking in the establishment;
means for recording a check in time for the crew member at the establishment in the layover management module; and
means for establishing a departure date and time for the crew member in the layover management module.

8. A computer system according to claim 8 further including:
a server; and
means for transferring data from the layover management module to the server.

9. The computer system of claim 8 further including means for storing the data in the server.
